(19) United States
(12) Patent Application Publication
(10) Pub. No.: US 2015/0286294 A1
(43) Pub. Date: Oct. 8, 2015

(54) MODULAR PLAYING FIGURE FOR IDENTIFICATION BY TOUCHSCREENS

(71) Applicant: Touchpac Holdings, LLC, New York, NY (US)

(72) Inventors: Johannes Köpcke, Dresden (DE); Karin Weigelt, Chemnitz (DE); Matthias Förster, Dresden (DE); Anja Richter, Niederwurschnitz (DE)

(73) Assignee: Touchpac Holdings, LLC, New York, NY (US)

(21) Appl. No.: 14/438,483

(22) PCT Filed: Oct. 28, 2013
(86) PCT No.: PCT/EP2013/072508

§ 371 Date: Apr. 24, 2015

(30) Foreign Application Priority Data
Oct. 26, 2012 (EP) 12190140.9

(51) Int. Cl. G06F 3/0354; A63F 13/23; G06F 3/044

(52) U.S. Cl. CPC G06F 3/03543; G06F 3/044; A63F 13/23; G06F 2203/04104

(57) ABSTRACT

The invention describes a modular playing figure which consists of at least a first and a second module, wherein the first module is a basic object and the second module is an identification means, and the identification means has an electrically conductive layer.

The invention relates to a modular playing figure which can be identified by touchscreens, wherein said playing figure comprises a first and a second module, and the first module is a basic object having an at least partially electrically conductive surface, and the second module is an identification means, which has an electrically conductive layer. In addition, the invention relates to a system comprising a modular playing figure and a touchscreen, wherein the playing figure has preferably been brought into contact with the touchscreen.

Board games are popular games with which a number of players can play with or else against one another. Generally, a substrate acts as the playing plane on which the players need to follow a predetermined route on the play area with their playing figures. The route, i.e. the moves made by the figures, can be made more difficult by tasks which need to be performed, with the result that a figure only reaches its destination when all of the tasks have been mastered successfully.

Board games have been modernized over the course of the years and have been provided with electronic component parts. Thus, for example, there are board games which play a note or even complete melodies at defined points in time over the course of play. The tasks which need to be performed by the players can also be read out by a computer integrated in the board game and changed by the players.

Highly complex games which now only have little in common with the original board game have now been introduced into casinos. For example, cameras or other electronic equipment are used to identify the die roll.

The prior art also describes playing cards made of paper or paperboard which can be read with the aid of a reader. These playing cards can be exchanged among players and the players can compete against one another using their cards.

Resistive or capacitive touchscreens have been used to operate machines more easily. Since the touchscreens have entered everyday life, however, they can be used for a large number of applications and are of great significance in daily use. In order to perform an input on a capacitive screen (also referred to as touchscreen or area sensor), special styluses can also be used in addition to the fingers. The capacitive touch-sensitive screen detects the position of the stylus which changes the capacitive coupling between row and column electrodes. The input is often performed by a user's finger or fingers on a capacitive touch-sensitive screen. In general, the touchscreen is accommodated in an electrical device. Such devices are, for example, smartphones, cellular telephones, displays, tablet PCs, tablet notebooks, touchpad devices, graphics tablets, televisions, PDAs, MP3 players, trackpads and/or capacitive input devices, without there being any limitation to these devices. Touchscreens are also known as area sensors or sensor screens. An area sensor does not necessarily need to be located in front of a display. For example, this can also be formed and used as a touchpad or the like. The touchscreens can identify a plurality of simultaneous touches. These so-called multitouch inputs can be used in particular to rotate or scale displayed elements, for example. This is known to the user from daily use with the smartphone. The area sensor is in this case preferably configured as so-called projected capacitive touch (PCT) technology. Variants of the PCT technology are, for example, mutual capacitance and self-capacitance, which can be configured as mutual-capacitance touchscreens and self-capacitance touchscreens.

In the prior art, such a touchscreen comprises in particular an active circuit, the touch controller, which is connected to a structure of electrodes. In the case of a mutual-capacitance touchscreen, these electrodes are generally divided into transmission and reception electrodes. The touch controller actuates the electrodes preferably in such a way that a signal is transmitted between in each case one or a plurality of transmission electrodes and one or a plurality of reception electrodes. The purpose of a touchscreen as described in the prior art is in particular the detection of fingers or special input devices and the position thereof on the surface of the touchscreen. For this, the introduction of, for example, a finger has the effect that the signal between the electrodes is changed. In general, the signal is reduced because the introduced finger picks up part of the signal from the transmission electrode and thus a smaller signal arrives at the reception electrode.

The entry of the touchscreens into daily life and their universal usability is increasingly taken as an inducement to provide new technologies which increase the usability of the touchscreens. To this extent, there are already games which have been known for years as board games and can now be played with the aid of or on the touchscreen. These include not only simple games which are operated with the aid of fingers, but also more complex games in which a playing figure is used. A player purchases the figure and can enable, for example, new features of his vehicle (his playing figure) with the aid of the touchscreen or the program existing on the electrical device.

In addition, the prior art discloses playing figures with the aid of which a player can play games on the touchscreen. In this case, the base area of the playing figures is structured in terms of its conductivity so that only certain, defined subareas of the playing figure base are electrically conductive. These subareas give, when interpreted as a whole, a data code. If the playing figure is brought into contact with a touchscreen by a user, the data code can be detected and identified by a device having a touchscreen.

Over the course of the game, the player can make moves on the touchscreen with the modular playing figure or manage tasks. For this, the player touches the playing figure on the coupling areas provided for this purpose and brings it into contact with the touchscreen. The objects described in the prior art, in particular playing figures, are only provided with an electrically conductive layer on these coupling areas. Thus, they can also only be detected and identified by a touchscreen when the player touches these coupling areas. The fact that the playing figures can only be touched on the coupling areas provided for this purpose in order to be detected by the touchscreen has a disadvantageous effect on the usability of the playing figures. This applies primarily when the player is a child since children usually have restricted motor skills and have smaller hands in comparison with adults.

For example, a mother in a customer review of the product “Spin Master—AppMATes Twin Pack Mater & Finn” produced by Disney on the Amazon website mentions, by way of criticism, this disadvantage: “It is nevertheless strenuous to keep a precise hold on the side windows, without which the Appmate does not function, for a long period of time and the control is substantially more awkward than using two fingers in the digital InApp version” (cf. http://www.amazon.de/AppMATes-6019414-Disney-Pixar-Mater/dp/B006YAV6EE/ref=pd_rhf_se_p_t_{—}4_GPCA, as at Oct. 11, 2013). The fact that the playing figures can only be touched on certain electrically conductive coupling areas provided for this purpose therefore not only reduces the usability of the playing figures described in the prior art for children, but also for other users with restricted motor skills, for example for older people. This is even more of an undesired disadvantage since the demographic development in industrialized nations is increasingly moving toward an increasing number of older people wishing to be involved in modern developments in the games industry and in many family relationships it is precisely the grandparents and the children that have an inclination and time to play with one another.

One disadvantage with the figures known from the prior art furthermore consists in that the fixed, nondetachable connection between the playing figure and the structured subareas is in the base of the figure. A change in the design of the structured electrically conductive subareas in the base of the figure, for example in order to realize different playing figures (individualization) or in order to make an improvement in terms of copy protection, necessarily results in a considerable change in the manufacture of the figure. In addition, a technical change to the production processes or manufacturing machines and the process sequences is thus required.

In addition, the prior art discloses capacitive information carriers which have a conductive layer on a nonconductive substrate and are characterized in that touch points, coupling area and conductor track are implemented in one plane through an electrically conductive layer. This is a considerable disadvantage in terms of the physical configuration of a playing figure and represents a restriction to the production processes. Certain three-dimensional playing figures cannot be realized owing to this restriction (WO 2011/154524 A1).

The object of the invention was therefore to provide playing figures which do not have the disadvantages of the prior art.

The object is achieved by the independent claims. Preferred embodiments are given in the dependent claims.

It was entirely surprising that a modular playing figure can be provided which can be adapted easily and in few production steps to new uses and which can furthermore be touched at any desired point on the surface in order to be detected by the touchscreen, owing to its design and the configuration of its surface. Nothing of this nature is known from the prior art.

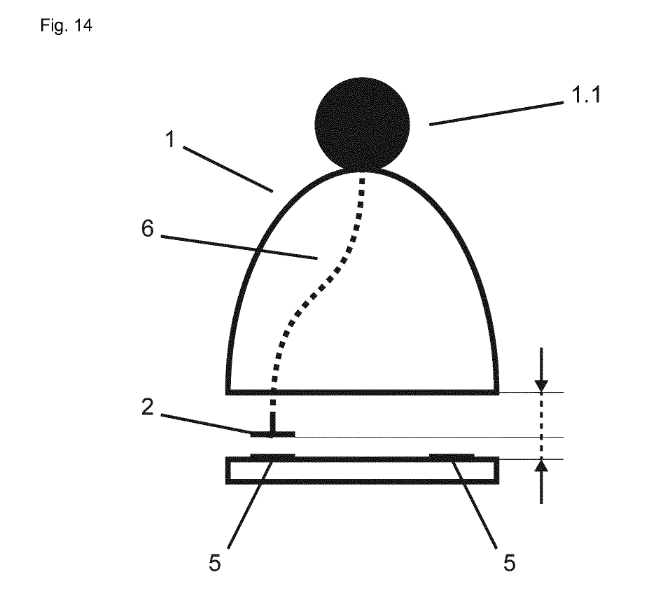

Furthermore, it is entirely surprising that one or more coupling areas can also be configured in another layer with a modular playing figure, for example the touch points. This results surprisingly in the advantage that, for example, the coupling area can be configured in a further dimension, i.e., for example, at the top of a playing figure, while the touch structure still remains in a layer on the base of the playing figure (FIG. 14).

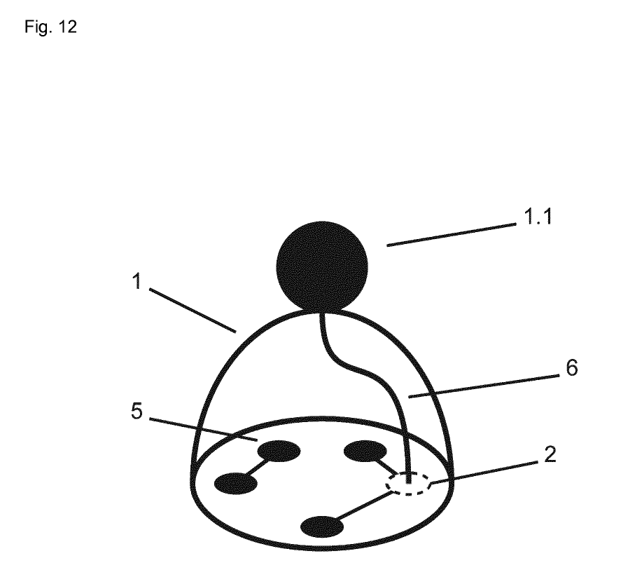

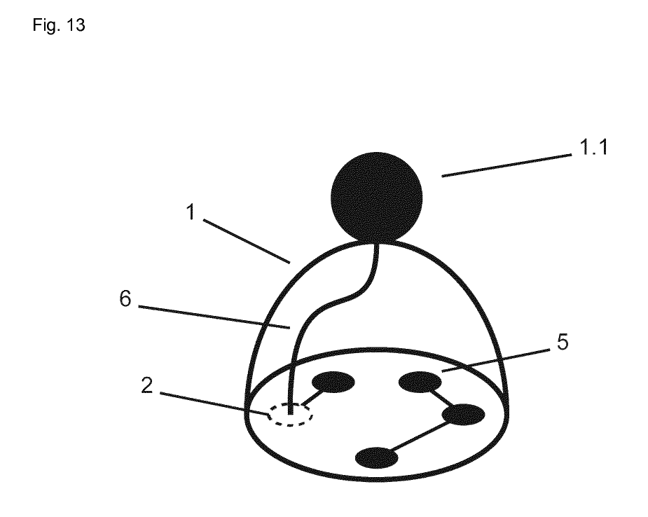

In addition, it is surprisingly possible, owing to the modular design of the playing figure, to implement different touch structures by virtue of different combinations of modules. This is a clear advantage over known solutions (FIG. 12 or 13).

It was entirely surprising that, owing to the modular design of the playing figure and in particular the reversible connection of the identification means to the basic object, completely new and flexible application concepts can be realized. In this sense, the invention describes, by way of example, but without representing any restriction, applications in which a basic object which remains physically identical can change its digital appearance in fully flexible fashion and without any problems thanks to the reversible identification means. In one example, without this representing a restriction, relating to the use as a modular playing figure, a basic object can therefore, by virtue of replaceable identification means, be a dog, a cheetah, a lion or else a giraffe.

In this example, the real external appearance of the basic object does not change in any way. Owing to the reversible connection, different identification means can be fitted to the basic object, as a result of which the physical appearance of the playing figure does not change but the digital one does. If, in one example, the basic object 1 is connected to identification means 1, this combination in a system with a touchscreen produces, digitally, a dog. If, however, basic object 1 is now connected to identification means 2, this combination produces, digitally, a cheetah. The individualization of the data code therefore enables digitally a completely different association between the physical basic object and the digital contents. This argument can be continued for n+1 identification means with the same basic object.

In a further configuration in this regard it is possible for a basic object to be coupled to an identification means which contains different coupling-in points on different data codes and therefore can initiate different combinations and identifications on touchscreen devices. In one example, without this representing any kind of restriction, an identification means contains two data codes, each having a coupling-in electrode. If the basic object is coupled in at the first coupling-in electrode of the first data code on the identification means, it initiates a different interaction with a touchscreen device than the coupling of the same basic object to the same identification means, but at the coupling-in electrode of the second data code.

In a first aspect, the invention relates to a modular playing figure for identification by touchscreens, comprising at least a first and a second module, wherein
a. the first module is a basic object having an at least partially electrically conductive surface, which is electrically conductively connected to a coupling electrode on a contact area, and
b. the second module is an identification means comprising at least one electrically conductive layer, wherein the electrically conductive layer comprises at least one coupling-in electrode,
   wherein the basic object and the second module are connected to one another in a cohesive, force-fitting and/or form-fitting manner in such a way that the coupling electrode on the contact area of the basic object and the coupling-in electrode of the second module have been brought into contact with one another, wherein preferably the electrically conductive elements of the modules are not provided in a developable surface.

The term “undevelopable surfaces” is used in geometry for those surfaces whose Gaussian curvature at at least one point on the surface is unequal to zero. The opposite of undevelopable surfaces are developable surfaces, which can be transformed into a plane without any internal distortion of form. In order to better illustrate this, the two solids cylinder and sphere will be described by way of example here. The lateral surface of a cylinder can be transformed into a plane (rectangle) by being developed. In contrast, it is not possible for the surface of a sphere to be developed into a plane. In a preferred embodiment, the basic object has an electrically conductive surface.

Playing figures within the meaning of the invention are preferably objects, things or articles which are suitable for being provided with an identification means and which can be coated with a conductive surface. They are preferably figures whose exterior has long been used in the sector of board games. Particularly preferably, they are playing figures such as vehicles, animals, fantasy figures from children's and youth literature or the toy industry, without these representing any restriction.

The surface of the basic object is in this case configured in such a way that it is possible for the user to touch this surface at any desired point. The touch is not restricted to individual areas provided for this purpose. The surface of the basic object can in this case either be conductive over the full area or structured partially in such a way that it is nevertheless possible for the user to touch the basic object at any desired point in order to enable interaction with touchscreen devices. For example, the electrically conductive layer can be configured as a grid network, a lattice structure or as a combination of various geometric elements electrically connected to one another, for example lines, circles, rectangles, without these representing any restriction. In this case, the condition is to be met whereby the areas lying between the elements which are not electrically conductively coated do not exceed the minimum resting area of a finger, in order that the capacitive coupling-in can be ensured by the user when touching any point.

Furthermore, the basic object can preferably also completely consist of conductive material. It may also be preferred for an electrically conductive layer to be provided at least partially in, between and/or on an electrically nonconductive material. As a result, the use of the playing figures is considerably facilitated in comparison with the playing figures described in the prior art and the enjoyment from playing is increased, primarily for children and older people. In particular, the facilitated use of the modular playing figure makes it possible for children and adults to play with one another on an equal footing since any disadvantages the children have owing to lack of motor skills are compensated for by the larger surface available for them to touch.

The easier use of the modular playing figure furthermore reduces any negative impact of errors on the game as a result of losses of information which can result from incomplete touching of the coupling areas. This increases the enjoyment gleaned from the play and improves the qualitative appearance of the modular playing figure in comparison with those playing figures described in the prior art having an electrically nonconductive surface.

It was completely surprising that the identification of the identification means by the touchscreen is not only less susceptible to faults but is performed more quickly and also substantially more accurately than is the case with conventional playing figures. This improvement is achieved by the modular design of the playing figure and in particular by the fact that at least some of the conductor tracks and the coupling-in electrode are not in direct contact with the touchscreen.

Furthermore, by virtue of the easier use of the modular playing figure, the complexity of the tasks to be achieved and of the games available on the touchscreen can be increased. By introducing the use of another finger or the other hand, it is possible for one player to implement more than one action more easily at the same time, for example touching the modular playing figure with one hand and swiping or typing on the touchscreen with the other hand. It was entirely surprising that even small children are able to implement complex motor tasks which need to be performed with both hands by virtue of the application of the modular playing figure.

By virtue of the modular design of the playing figure, it is possible to individualize the playing figure without changes to the apparatus of the manufacturing machines in the production process needing to be performed for this purpose. Therefore, an essential advantage of the present invention in comparison with the prior art consists in that the modules of which the playing figure consists can be manufactured separately. In the case of the playing figures known from the prior art, therefore, no individualization is possible without considerable complexity in the manufacturing sequence. A completely new playing figure needs to be produced.

Surprisingly, owing to the modular design of the playing figures, different touch structures can be realized by different combinations of modules.

Furthermore, the principle of the modular design can be applied easily to other objects, with the result that new use areas and interaction possibilities with touchscreens are opened up, for example adapting packaging for use on the touchscreen. Therefore, objects from everyday life can be brought into contact with a touchscreen and can interact with this touchscreen although these objects were not previously usable for such an application.

Modular objects can then, if appropriate, be used not only for playing, but rather people with restricted motor skills, for example older people, can find them useful in some way in managing with everyday life. The following will be mentioned by way of example:

operating various domestic appliances by control via a touchscreen surface, wherein the control does not take place directly by means of laborious typing on the touchscreen, but is performed indirectly via a modular object which facilitates operation or even makes it possible for the first time, or the operation of shutters, garage doors or heating systems.

Furthermore, a further completely surprising advantage consists in that the modular design of the playing figures makes it possible for children and adults to have an additional play experience during construction of the figures. While non-modular playing figures need to be used precisely in the way for which they were purchased, the particular experience of playing figures within the meaning of this invention consists in “creating” the individual figure oneself first. Therefore, there are increased degrees of freedom in the creative configuration and use of the playing figures for the user.

Surprisingly, owing to the use of modular playing figures, completely new play concepts and marketing strategies can also be realized within the meaning of this invention. In one example, but without this representing any kind of restriction, a game with x basic objects and y identification means is brought onto the market. In contrast to conventional games with non-modular playing figures, a new edition of this game can be configured such that z further identification means extend the x basic objects. It is thus possible, for example, to equip basic objects with additional features retrospectively, for example by means of adding new weapons.

Not least, modular playing figures can be realized more economically and with greater environmental friendliness in contrast to non-modular objects. While a new edition of non-modular playing figures in any case also requires the production of new figures, within the meaning of this invention, a new edition can also be realized merely by means of new identification means. As a result, savings are made in the planning, production and logistics in terms of costs and resources. The material and energy consumption is therefore minimized for producing the new edition. It was furthermore fully surprising that the playing figures according to the invention last longer than those from the prior art. Furthermore, the playing figures wear to a lesser extent through use that those from the prior art. This also applies, for example, to paint or varnish layers which are applied. This is particularly advantageous when smaller children are using the playing figures because smaller children tend to sometimes put them in their mouths as well.

Within the meaning of the invention, an individualization describes a change in an existing object, for example a playing figure, in order to produce, for example, variants thereof or generally to provide different playing figures which are identified as being different by the touchscreen. In particular, an individualization within the meaning of the invention refers to the provision of a playing figure with specific features which distinguishes it from other (identical) playing figures on interaction with a touchscreen. With the aid of the invention, it is now possible to produce a basic object which is connected to an individualized second module. The basic object has an electrically conductive surface, which is connected to a coupling electrode on a contact area. The second module is applied to the contact area of the basic object. The second module is in the form of an individualized identification means and has at least one electrically conductive layer, which comprises at least one coupling-in electrode. In order that the modular playing figure can interact with a touchscreen, it is preferable if there is capacitive coupling or direct electrical conductivity between the two modules, wherein this coupling or conductivity is produced in particular between the coupling-in electrode of the second module and the coupling electrode on the contact area of the basic object. The coupling electrode of the basic object produces an operative connection between the electrically conductive layer of the second module and the electrically conductive surface of the basic object. The user touches the basic object, in particular its surface.

The individualization of the modular playing figure is performed by the identification means, which is replaceable if the connection technology permits this. The identification means is applied to the contact area of the first module in a cohesive, force-fitting and/or form-fitting manner. The connection can advantageously be reversible or irreversible, wherein a reversible connection is preferred. These connection techniques are known to a person skilled in the art and such a person will know which fastening means can be subsumed under this. The identification means can, within the meaning of the invention, also be referred to as label or pedestal. A person skilled in the art will recognize from the configurations of the invention that the second module can be configured with different shapes and can also be connected to the first module by various methods.

A modular playing figure within the meaning of the invention can be any three-dimensional structure which can be brought into contact with a touchscreen. The physical limits of a touchscreen will be known to a person skilled in the art. For example, the possibility of the modular playing figure being configured such that it is 10 m large and 500 kg in weight is ruled out since with these dimensions it cannot be brought into contact with a touchscreen, or can only be brought into contact with a touchscreen with difficulty. However, consideration should be given to the possibility of the playing figure with such dimensions having a region to which the second module is applied and on which a touchscreen can be held. Such a playing figure would then also need to be subsumed under the features of the invention. However, playing figures are preferred which can be moved and lifted by a user and which are moved by the user in such a way that they can be brought into contact with a touchscreen.

It is preferred for the basic object to have an at least partially electrically conductive surface. For this purpose, the basic object can be manufactured from an electrically nonconductive material. The material is preferably selected from the group consisting of plastics, paper, cardboard, wood, wood-base material, foil, composite material, glass, ceramic, printed circuit board material, textiles, leather or a combination thereof. The material of the basic object is in particular an electrically nonconductive material which preferably has a low weight. Transparent or opaque materials can be used. Preferred plastics include in particular thermoplastic plastics, PVC, PETG, PV, PETX or PE.

It may be preferable for the electrically conductive layer which forms the surface of the basic object to have good conductivity. However, it may also be advantageous to use a material with lower electrical conductivity for the surface of the basic object and to use a material with good to very good electrical conductivity for the electrically conductive layer of the identification means. Materials with very good electrical conductivity are, for example, materials based on silver. Materials with good electrical conductivity include, for example, carbon-based materials, for example graphite spray.

It is preferred for the first and second modules to be capacitively coupled or directly electrically connected to one another. A capacitive transfer within the meaning of the invention is preferably the transfer of the capacitive effect from a coupling electrode of a first module to a coupling-in electrode of a second module, wherein the coupling-in electrode of a second module is, for example, without this representing any restriction, a data point of a capacitive identification means. The transfer of the capacitive effect takes place in this case either as a result of capacitive coupling or as a result of galvanic coupling.

The first module and the second module can have electrically conductive regions which, on connection of the first module to the second module, are arranged with respect to one another in such a way that capacitive coupling between the coupling electrode of the basic object and the coupling-in electrode of the second module takes place. Such an arrangement provides the possibility of as large a free space as possible in the case of the external visual design of the modular playing figure and increases the attractiveness of the use thereof.

In addition, it may be advantageous for the modules to be connected to one another electrically directly, for example via electrically conductive conductor tracks, and thus for electrical conductivity to be provided between the first and second modules. It may be advantageous if one or more identification means are applied directly or indirectly to the basic object. The identification means can be applied to different sides of the basic object, with the result that, for example, the modular playing figure can be brought into contact with a touchscreen in different orientations. It was entirely surprising that the detection of the different orientations of the modular playing figure can be used in order to initiate different events on the touchscreen and to positively influence the further development of a game shown on the touchscreen in a different way.

Furthermore, the different identification means can have different electrically conductive layers and can therefore also be identified as being different by the touchscreen. As a result, games for several players with different modular playing figures can be provided, wherein each playing figure represents a different character in the game. Accordingly, it may be preferable if the basic object has more than one contact area for applying the identification means. The contact area of the basic object can be configured as desired, wherein it only needs to be suitable for fastening the identification means and the electrical coupling between the basic object and the identification means needs to be ensured by means of the coupling electrode. It may also be advantageous if several identification means are applied one on top of the other to the basic object and are only then completed. In particular, it is preferred for the identification means to be applied one above the other, with the result that one lies on top of the other or the identification means are applied in such a way that they are positioned next to one another on the surface of the playing figure.

In a preferred embodiment, the coupling electrode is in the form of an electrically conductive layer on the contact area of the basic object at least as a subarea. The contact area is advantageously arranged on the base of the basic object, wherein any other position on the basic object can also be advantageous. The coupling electrode is preferably in the form of a structured, electrically conductive subarea, such as, for example, a completely filled circle area, a circular ring, a partially interrupted circular ring or a completely filled base area of the basic object. Advantageously, the coupling electrode can assume any geometric shape or arrangement on the contact area of the basic object. It is advantageous if at least a subregion of the contact area is flat, with the result that flat contact with a touchscreen can be produced.

Since the coupling electrode is in particular electrically conductive, it may be preferred for one or more electrically conductive fastening means to be applied to the contact area of the basic object and to be present at least as part of a functional element. The term fastening means is known to a person skilled in the art and such a person will subsume under this term in particular means consisting of metal or plastic which are used in the production of the modular playing figure in order to fix something. This may be nails, screws, plastic screws, snap fasteners, rivets or other means which are used for fastening. Within the meaning of the invention, the term fastening means can be used synonymously with the term connecting means. It was completely surprising that such a fastening means can be used as a coupling electrode, which considerably simplifies further the production of the modular playing figure. The fastening means can also supplement or replace the coupling electrode and can be identified, for example, by a touchscreen with which the modular playing figure is brought into contact and can be used for determining the position and/or orientation of the identification means.

In a preferred embodiment, the identification means is in particular connected to the basic object by means of special injection-molding methods, for example in-mold methods or film insert molding, welding methods or adhesive bonding. A substantial advantage of the modular playing figure is its simple production from the individual modules and the possibility of individualization.

Film insert molding is used to refer to a special type of injection molding in which films are inserted into the injection-molding die prior to the plastics melt being injected. The inserts are printed films which can be reshaped three-dimensionally and then cut to size. In the case of preforming of the films, a distinction is drawn between the high-pressure forming (HPF) method and the thermoforming method. As a result, precise printed objects with high degrees of deformation can be produced. It is also possible to use further substrates, for example fabric, paper, wood veneer or any desired printed or structured films or foils, in the insert molding process. This is referred to as the in-mold method.

It may furthermore be advantageous if the identification means is fastened to the basic object by means of welding methods. It is possible to use, for example, ultrasonic welding, induction welding, energy beam welding or further welding methods suitable for plastics. The ultrasonic welding is a method for joining thermoplastic plastics and metal materials. The required heat is reached by a radiofrequency mechanical oscillation which is produced between the component parts as a result of molecular and interface friction. Therefore, ultrasonic welding belongs to the group of friction welding processes. The oscillations are transferred under pressure to the workpieces to be connected, namely the basic object and the identification means. They are heated and begin to soften, as a result of which the damping coefficient increases. The increase in the damping factor results in increased internal friction, which accelerates the temperature increase. The materials are in particular not heated to melting point. The connection is produced once the oxide layer has broken up substantially as a result of interleaving of the materials. The ultrasonic welding of the basic object and the identification means is characterized by very short welding times and high degree of efficiency.

It may of course also be advantageous to fasten the identification means to the basic object by means of adhesive bonding. It may also be particularly preferred to use electrically conductive adhesive to produce a direct electrical coupling. It is also possible to use a combination of electrically conductive and electrically nonconductive adhesives or to use so-called “z-conductive” systems. In the case of the latter group, the conductivity is only transmitted in one direction (that of the z-axis).

A large proportion of the playing figures disclosed in the prior art consists of a plastic, wherein the figures are produced using an injection-molding method. It was therefore completely surprising that the modular playing figures in a preferred embodiment can likewise be produced using such a method and the identification means can be brought into or onto the basic object using the injection-molding method. Preferably, for this purpose, the method of film insert molding (also referred to as in-mold labeling) is used. The method of film insert molding is generally known and is used, for example, for decorating plastic component parts. It is surprising that this method can also be used for connecting the identification means to the basic object. The electrically conductive layer of the identification means is in this case in particular pressed onto suitable plastic films (for example polycarbonate, polypropylene, polyethylene, etc.). Then, the film is cut to size, if appropriate deformed and inserted into the injection-molding die with the electrically conductive layer inward, manually or automatically. During the subsequent injection-molding process, the film joins onto the melt and is connected to the basic object after cooling. The identification means can be connected to the basic object during the production step of the basic object, which represents a considerable advantage in terms of the production of the modular playing figures.

It may be advantageous to produce the identification means and/or apply it to the basic object by means of an additive, semiadditive or subtractive method. In addition, it is preferred for the identification means to be produced by a printing method, preferably a mass printing method. In a preferred embodiment, the identification means is produced by a transfer foil method, preferably a metal foil transfer method, and particularly preferably by a cold foil transfer method. Mass printing methods, and also transfer foil methods are sufficiently well known to a person skilled in the art. However, it was completely surprising that such an identification means produced by the preferred methods can be connected to the basic object of the modular playing figure and above all an operative connection between the first and second module can be produced. This is achieved by the advantageous design of the modular playing figure. Within the meaning of the invention, the identification means can also only be in the form of an electrically conductive layer on the basic object, wherein it may also be advantageous for the identification means to consist of an electrically nonconductive substrate or material, on which an electrically conductive layer is provided, at least in regions. The identification means can advantageously be applied by means of additive methods such as printing methods, spraying methods, stamping methods, PVD and CVD methods, galvanic methods or subtractive methods such as laser structuring, brushing methods, milling methods etc. Semiadditive methods such as, for example, etching methods can also be advantageous. In one embodiment, the electrically conductive layer is applied to the substrate by means of a transfer method. In this case, in particular a foil transfer method, particularly a thermal transfer method is preferred. Such methods are known to a person skilled in the art. It is of course also possible for any other methods to be used for applying an electrically conductive layer.

It is preferred for the electrically conductive areas or layers of the identification means to be in the form of subareas, in particular filled circles or filled circular rings, wherein subareas are electrically connected by means of line structures, which within the meaning of the invention are also referred to as conductor track structures, and wherein at least one subarea is the coupling-in electrode. The advantageous individualization of the modular playing figures is in particular achieved by virtue of the fact that at least one identification means is applied to at least one contact area of the respective basic object. The identification means preferably has structured, electrically conductive layers or areas. If the modular playing figure is brought into contact with a touchscreen, the electrically conductive areas of the identification means are identified by capacitive coupling and interpreted as touch events, with the result that the touch events in total result in a data code. The structured, electrically conductive areas have specific characteristics which make it possible to make available different reidentifiable and distinguishable data codes. For example, such a data structure can comprise a plurality of completely filled circle areas with a specific diameter which are connected to one another via lines (line structures or conductor track structures). The coupling-in electrode of the second module can advantageously be a component part of the data structure. However, it is also possible to realize data structures in which the coupling-in electrode is not a component part of the data structure. The electrically conductive layers or areas are preferably electrically coupled to the coupling electrode of the basic object. This can take place in particular by virtue of the fact that the coupling electrode and the electrically conductive areas of the identification means are in close contact or touching contact, with the result that at least part of the electrically conductive areas of the identification means, in particular the coupling-in electrode, overlaps as much as possible with the coupling electrode. Advantageously, the identification means is fastened to the contact area of the basic object in such a way that the distance between the electrically conductive coupling electrode and the coupling-in electrode of the identification means is as small as possible. The electrical potential of the surface of the basic object is preferably coupled into the electrically conductive areas of the identification means, in particular the data structure formed thereby, in particular capacitively, preferably via the coupling electrode. If the modular playing figure is touched by a user and is brought into contact with a touchscreen via the identification means, the electrical device having the touchscreen can detect and identify the playing figure, in particular the data structure or data code formed by the electrically conductive areas and the conductor track structures.

It was entirely surprising that, in addition to the data structure, also the orientation and position of the modular playing figure can be determined on the touchscreen. By permanent tracking of the playing figure on the touchscreen, a rotation of the figure can also be determined. This can be achieved sometimes by virtue of the fact that figures that have been identified once with their associated data structure are tracked by means of the device containing the touchscreen and history, which is also possible, under certain preconditions, after a partial loss of touching contact by the user. Therefore, an individualization of the respective playing figure which has previously not been described is achieved in a simple and inexpensive manner.

In a further preferred embodiment, the first and/or second module of the modular playing figure has at least one further coating. The coating can be applied to the playing figure for protection or for esthetic reasons. Layers of paint which have a protective effect so that the playing figure firstly has an esthetic configuration and is secondly protected from the action of forces are of course also known to a person skilled in the art.

In a further aspect, the invention also relates to a system comprising a previously described modular playing figure and a touchscreen or a device containing a touchscreen, wherein at least part of the playing figure has been brought into contact with the touchscreen. It should be noted that the above-described embodiments of the modular playing figure can be applied analogously to the claimed system. The playing figure preferably comprises at least two modules, wherein the first module is a basic object and the second module is an identification means. The modules are connected to one another by means of cohesive, form-fitting and/or force-fitting connecting means, to be precise in such a way that the coupling electrode on the contact area of the basic object and the coupling-in electrode of the second module have been brought into contact with one another.

The connection between the modules can advantageously be reversible or irreversible, wherein a reversible connection is preferred. By virtue of the preferred connection of the two modules, capacitive coupling between the two is achieved since the basic object has at least one electrically conductive area and is capacitively coupled to an electrically conductive layer or area of the identification means via a coupling electrode. By a user touching the electrically conductive surface of the basic object, a touch input on the touchscreen can be achieved via the identification means as soon as both have been brought into contact with one another. In practical terms, this means that a detectable input on the touchscreen is achieved as soon as a user brings the playing figure into contact with the touchscreen by virtue of a permanent or non-permanent touching contact.

An advantageous characteristic of the modular playing figure is its conductivity. If, instead of a finger, a preferred playing figure is brought into contact with a touchscreen, the at least partially conductive surface of the playing figure preferably effects the same response of the touchscreen as a finger touch. However, the conductive structure is structured in regions. Within the meaning of the invention, structured means that the electrically conductive layer or area can be configured differently; it can consist of full-area circles (data points) and conductor track structures, wherein the effect which is comparable with the introduction of a finger is intended to be maximized at certain points, in particular the data points, in order to be as easily identifiable as possible for the touch controller of the touchscreen. Therefore, the playing figure or the data structure produced by the electrically conductive areas is capable of being evaluated by a data processing system connected to the touchscreen.

It is known to a person skilled in the art that an input can be performed by means of one or more fingers on a touchscreen or an area sensor (single-touch or multitouch). The technology of area sensors and the principles of inputting, for example by means of which characteristics of a finger an input is performed, are likewise known to a person skilled in the art. For example, in addition to the electrical characteristics of the finger (for example conductivity), the pressure of the input or the resting area resulting therefrom of the finger, the distance from the area sensor or unintentionally introduced material (such as dirt, for example) can also influence the input. The preferred modular playing figure, as a result of the structuring of the conductive region of the identification means, achieves the same effect on a touchscreen as a finger, namely an input at a position on the touchscreen which is defined by the conductive regions of the identification means. A person skilled in the art could therefore embody the electrically conductive areas of the identification means in such a way that the characteristics of an input with a finger are simulated and an input on a touchscreen can be achieved with the electrically conductive areas, without any significant experimental complexity being involved.

In one non-restrictive example of a preferred identification means in interaction with a touchscreen with an electrode arrangement in the form of a grid, suitable structuring of the data point is, for example, a filled circle with a diameter of 1 to 20 mm, preferably 4 to 15 mm and particularly preferably 6 to 10 mm. Since a touchscreen is suitable for determining the position of fingers, a filled circle area of an identification means is likewise determinable in the same way by the touchscreen. The touchscreen or the device containing the touchscreen can advantageously not distinguish whether the input has been performed by the identification means or by a finger.

In this regard, it may be advantageous if a user touches the modular playing figure permanently or non-permanently. Under certain circumstances, a touchscreen does not detect all parts of the data structure, i.e. of the electrically conductive areas of the identification means (data points are not detected owing to an unfavorable angle between conductor track structures within the data structure or as a result of the material, for example owing to poor conductivity). The software which evaluates and interprets the touch events or the determined touch points then needs to have such tolerances that it allows individual touch points to disappear and, based on the history, can understand whether the playing figure is still on the touchscreen. In the case of non-permanent touching, parts of the electrically conductive areas can under certain circumstances no longer be detected owing to a lack of coupling to the user.

The modular playing figure can be used to be able to use special applications for devices containing touchscreens. Thus, for example, playing figures can be used as different characters with different characteristics and capabilities in game applications.

It may be advantageous in this regard if interaction between at least one figure, a user and/or touchscreen or a device containing a touchscreen takes place. For example, inputs can be performed by the user on the touchscreen or only the playing figure can have been brought into contact with the touchscreen. Different interactions between figures and user touches can take place, for example holding a playing figure and scrolling with the other hand in order to select a certain weapon or typing with a finger in order to actuate a weapon. That is to say that the playing figure which has been brought into contact with the touchscreen and the touches on the touchscreen by the user can be combined in a variety of ways and supplement one another functionally.

It is likewise preferred to thus individualize any other type of three-dimensional object which can be connected to the identification means and to make such an object usable with a touchscreen. Such objects may be, for example, packaging on which invisible information is accommodated which enables access to further information (for example recipes, greetings, photos, videos, etc.). It is of course possible for the second module used as identification means to also be used to provide products with a certificate of authenticity or a test certificate which is not visible and can therefore only be forged with difficulty.

It may be preferred for measured values to be collected by virtue of rotation and/or translation of a playing figure on the touchscreen and stored as reference values, and for these reference values to be matched with other measured values at a later point in time in order to identify the figure. In this case, rotations through 360° or less are preferred. The values can advantageously be stored permanently or stored in a buffer store.

This is known to a person skilled in the art, inter alia, as teaching. Within the meaning of the invention, teaching means the collection and storage of optionally further-processed measured values of a figure with, for example, different orientation of the figure on the touchscreen, which are then later matched with other measured values in order to identify a figure. Depending on the application, it may be preferable not to teach the complete rotation, but only a section of a 360° rotation, for example when only certain shooting angles are permitted in a shooting game.

In order to fasten the modular playing figure on a touchscreen or to produce an optimum contact therewith, it may be advantageous to additionally equip the figure with a suction pad and optionally a mediating compound between the identification means and the basic object. The mediating compound consists of an elastic and/or flexible material and gives the suction pad room for movement in order to perform its function. In this case, the suction pad is connected at the upper end to the basic object and at the lower circular end rests on the identification means or is connected thereto (for example by means of adhesive bonding). The suction pad is a cup-shaped structure consisting of elastic material which is pressed onto a smooth surface by a negative pressure. During application, the air is pressed out of the suction pad and the difference in air volume resulting from the pulling action determines the force with which the figure is held on the touchscreen. The suction force which can be achieved in the process is proportional to the pressure difference and to the effective area. When pulled by the user, a primary negative pressure is produced between the suction pad and the identification means, and this bends the underlying area of the identification means concavely toward itself and produces a secondary negative pressure between the identification means and the touchscreen. As a result, the region below the rim of the suction pad is drawn firmly against the touchscreen and the region between the rim is drawn slightly upward, but generally to a lesser extent than would be the case as a result of incorrect treatment, and is flat enough for ensuring that it can safely be read by the capacitive touchscreen. If the identification means is connected to the basic object by a mediating compound, this is preferably more flexible when drawn than the draw in the opposite direction of the suction force with which the figure is held on the touchscreen. By virtue of special mechanisms in or on the basic object, it is naturally also possible for a variable suction force to be realized, which can be influenced by the user by means of interaction (for example actuation of a button or moving a lever on the figure). The interaction can also be initiated independently electronically by means of servo motors. The characteristics achieved thereby can be used to facilitate, for example, fixed positioning of the playing figure, to be able to implement an operation determined by the concept of the game (for example sliding of a playing figure without it being lifted), or in order to prevent unintentional detachment of the figures. In addition, characteristics can therefore also be achieved which are similar to those of magnetic fastening methods and therefore provide a very economic alternative since, inter alia, no magnets need to be introduced in the touchscreen.

The invention will be explained by the following example, without this example representing any kind of restriction. It should be noted that the term “label” is used synonymously with “identification means”.

Example with the following parameters
label diameter: 38.1 mm
number of data points: 4
diameter of a data point (applies for all data points): 7 mm
grid width: 4 mm
minimum distance between two data points (clear distance): 7 mm

The label is circular, and the total diameter is 38.1 mm (1.5″). The data structure is formed by four circular, electrically conductive solid areas (data points) which are connected to one another by lines. One of the data points is positioned fixedly at the outer rim, with the result that the rim of the data point is at a tangent to the outer rim of the label.

A grid is defined within the label area with a grid width of 4 mm (in each case for x and y directions). The further three data points can only be arranged on the grid. The reference point of a data point is in each case the mid-point. All of the possible positions thus produced form a basic set for positioning the data points. This basic set is restricted by the following further conditions:
The distance between the label rim and the mid-point of the respective data point to be positioned should not fall below a minimum value, wherein the minimum value is half the diameter of the data point: 3.5 mm
The distance between already positioned data points and the data point to be positioned needs to be a minimum value, wherein the minimum value is the sum of the diameter of a data point and the clear distance between the respective two data points: 14 mm

For reasons of usability (label does not have a preferred upper or lower side), a further set of possible positions (symmetry) is not required.

Therefore, a number of possible positions for the totality of four data points of 32 different data structures results for the above-selected parameters.

Table 1 shows the dependency of the number of different data structures on the selection of the parameters.

TABLE 1
Number of different data codes/structures
depending on the selected parameters

| | | | | | Clear | |
|---|---|---|---|---|---|---|
| | | | Diameter | | distance | |
| | | | of a | | between | Number of |
| | Label | Number | data | Grid | two data | different |
| | diameter/ | of data | point/ | width/ | points/ | data |
| No. | [mm] | points | [mm] | [mm] | [mm] | codes |
| 1 | 38.1 | 3 | 8 | 4 | 8 | 9 |
| 2 | 38.1 | 3 | 6 | 4 | 8 | 21 |
| 3 | 38.1 | 4 | 8 | 4 | 8 | 4 |
| 4 | 38.1 | 4 | 7 | 4 | 8 | 10 |
| 5 | 38.1 | 4 | 7 | 4 | 7 | 32 |
| 6 | 38.1 | 4 | 6 | 4 | 6 | 61 |
| 7 | 38.1 | 4 | 6 | 3.5 | 6 | 145 |
| 8 | 20 | 4 | 4 | 3 | 4 | 8 |

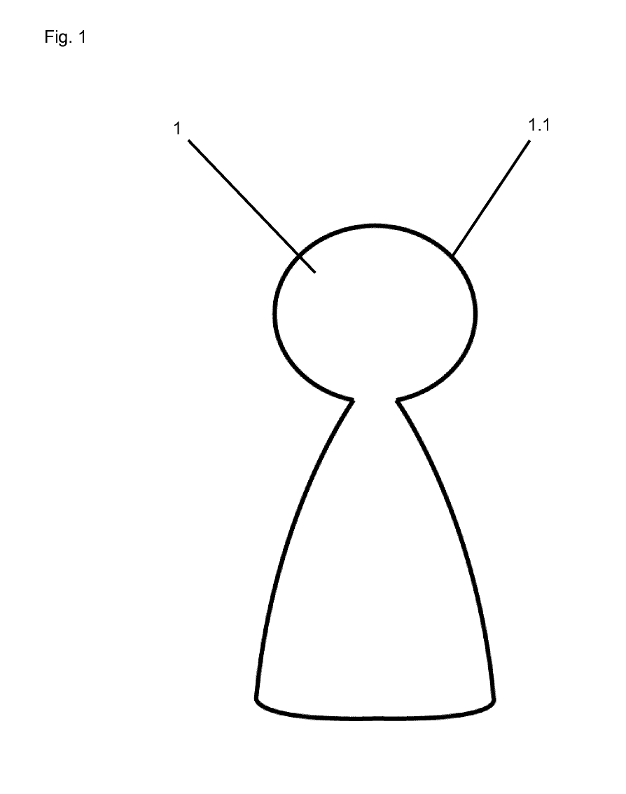

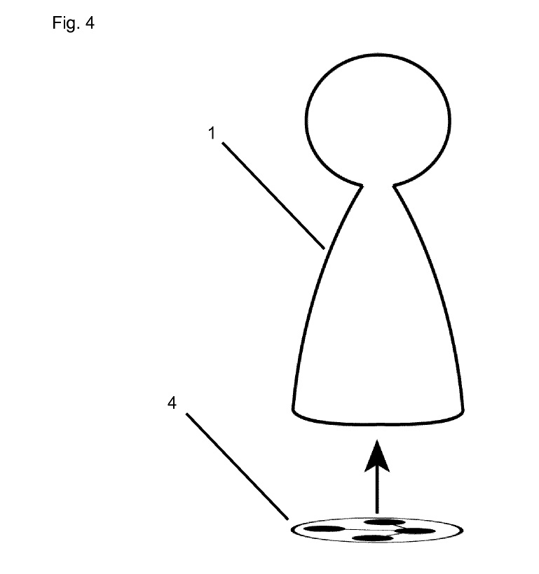

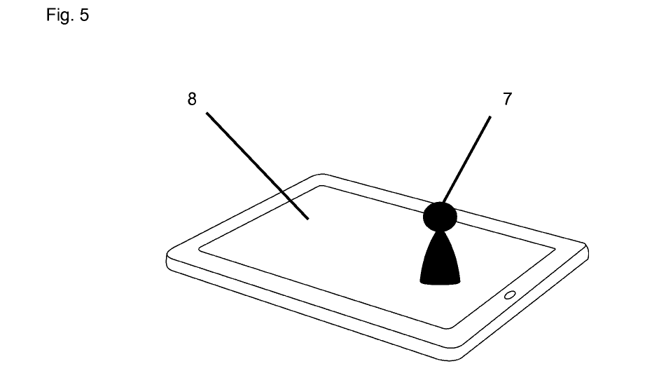

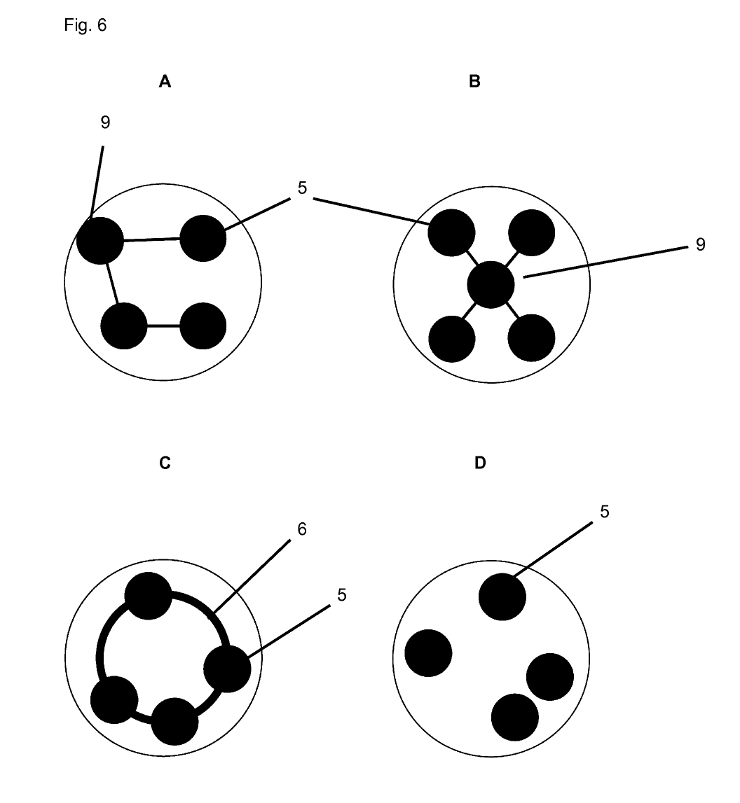

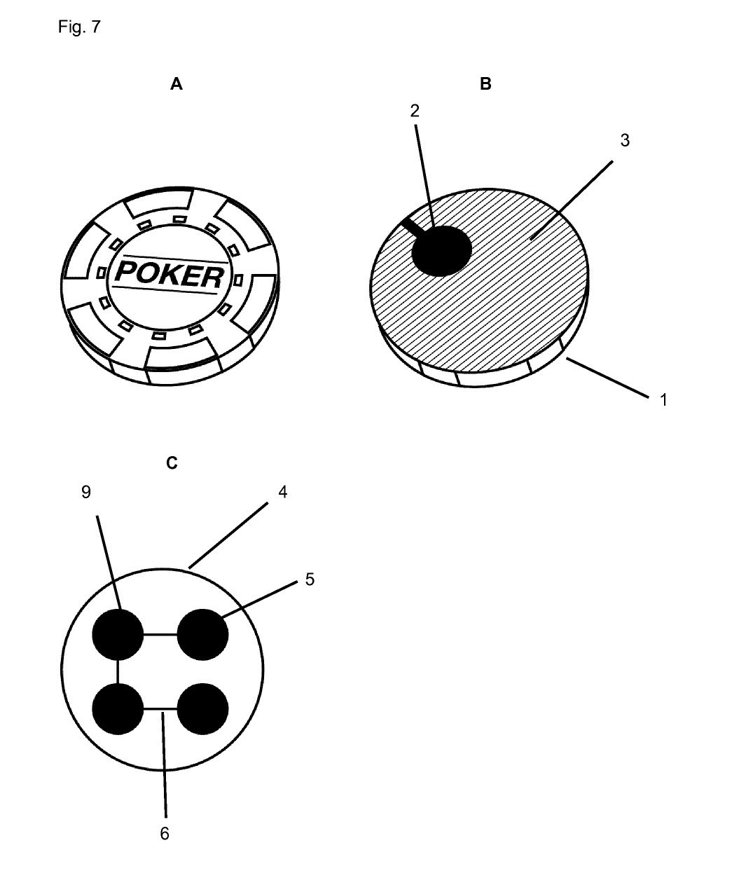

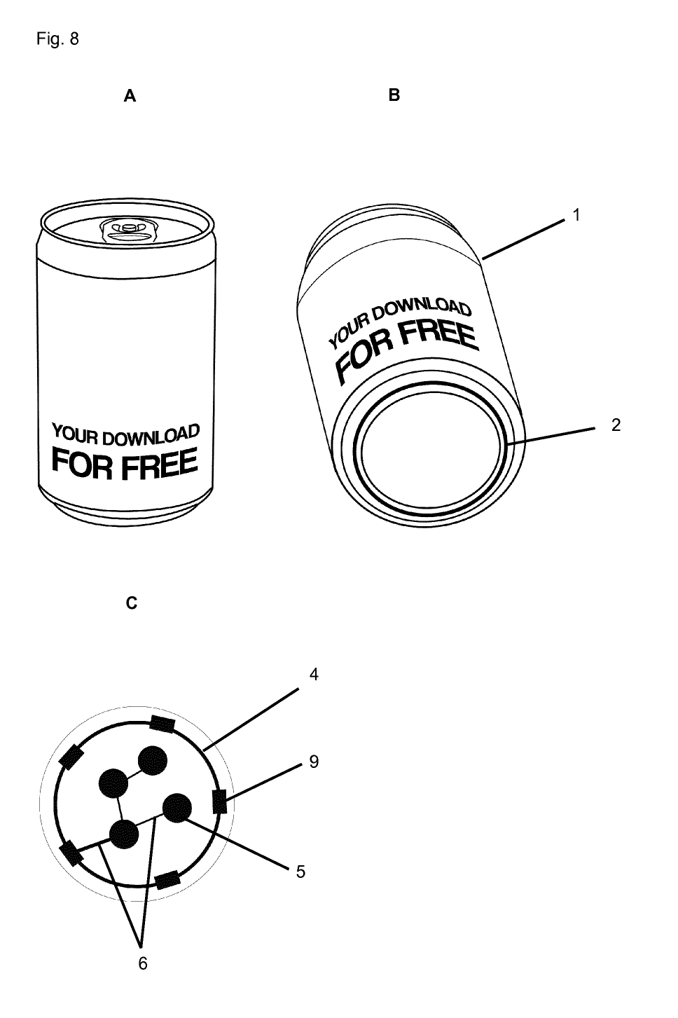

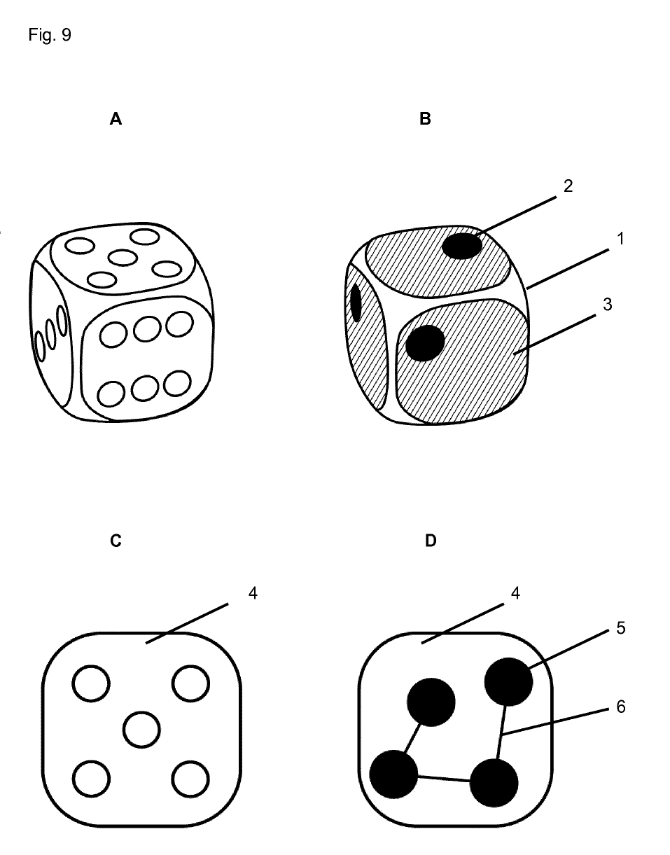

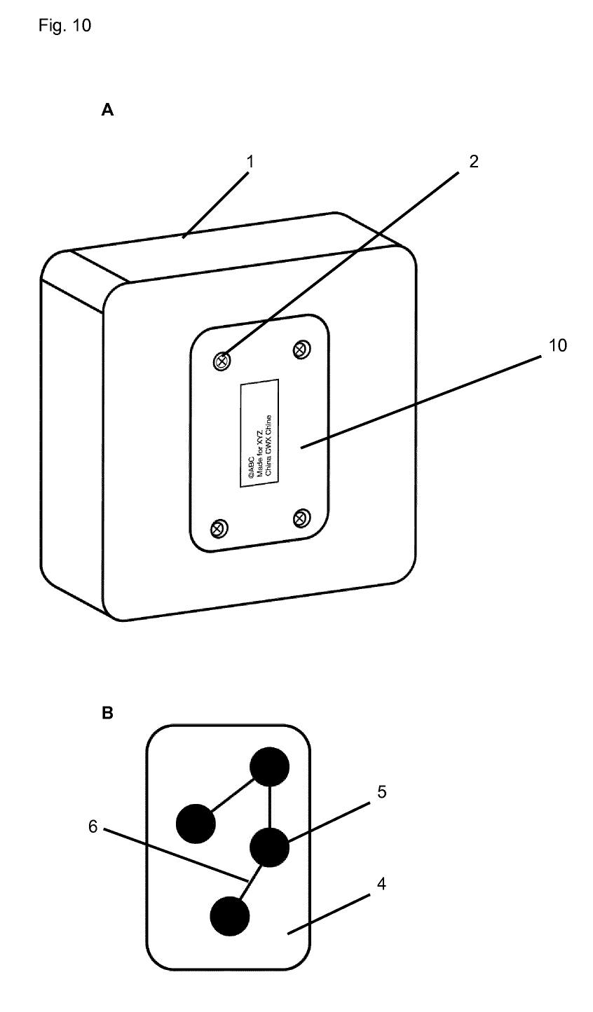

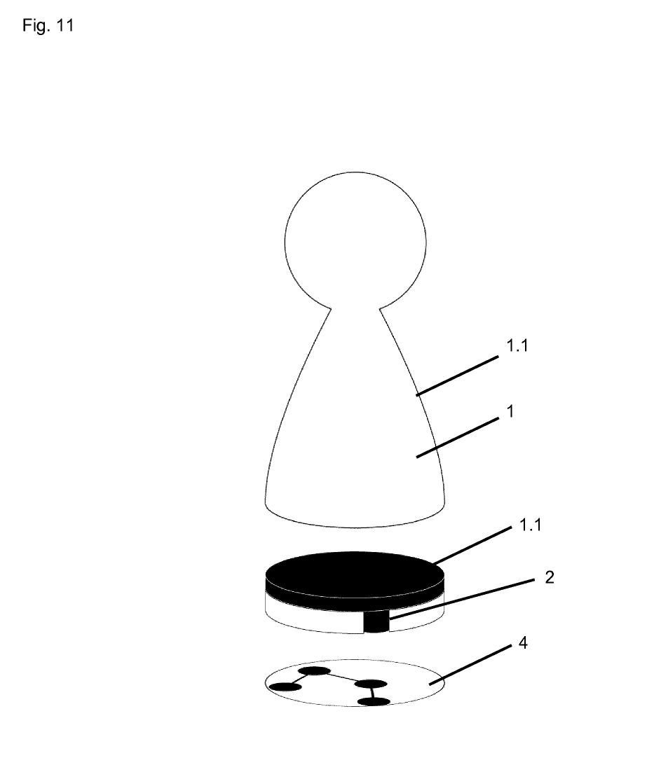

The invention will be explained by way of example below with reference to figures, without these figures representing any kind of restriction. The figures show the invention only in a few configurations, wherein it will be clear to a person skilled in the art from the figures how to additionally configure or embody the invention. In the figures:

| | |
|---|---|
| FIGS. 1, 2 and 3 | show views of an exemplary modular object |
| FIG. 4 | shows connection of identification means and |
| | basic object |
| FIG. 5 | shows modular object and touchscreen, brought |
| | into contact with one another |
| FIGS. 6A-D | show exemplary structures of the identification |
| | means |
| FIGS. 7A-C | show views of an exemplary chip |
| FIGS. 8A-C | show views of an exemplary can |
| FIGS. 9A-D | show views of an exemplary die |
| FIGS. 10A and B | show the use of a fastening means |
| FIG. 11-FIG. 14 | show illustrations of further preferred embodiments |

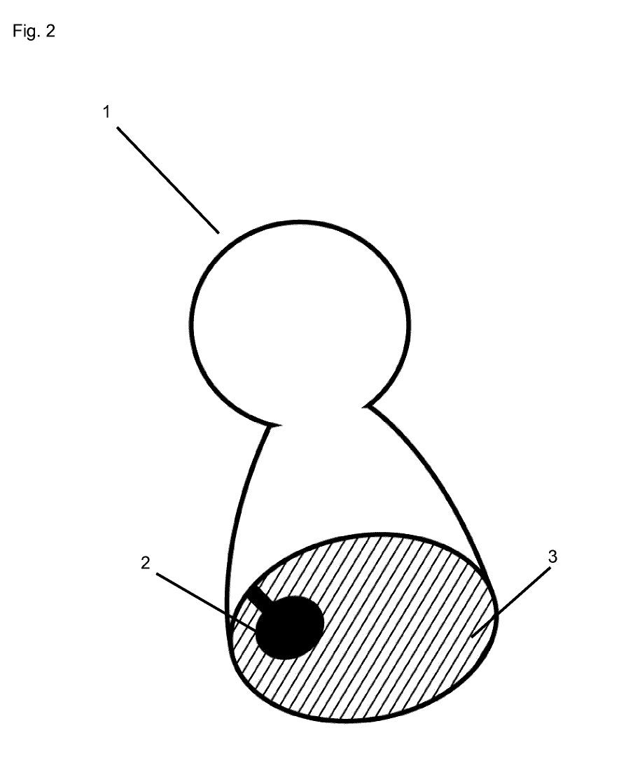

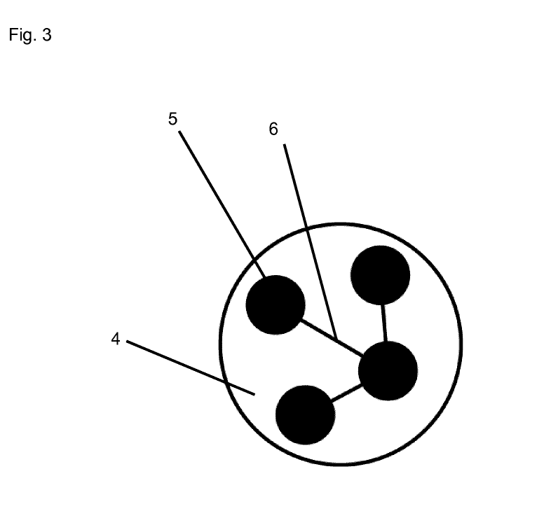

FIGS. 1, 2 and 3 show views of an exemplary modular object. Views of the modular object from the front (FIG. 1) and from the rear (FIG. 2) are shown. FIG. 1 shows the first module 1 and the coupling area 1.1. The coupling area 1.1 can be touched by a user, for example. The lower side of the modular object (FIG. 2) has a contact area 3 and a coupling electrode 2, which is electrically connected to the coupling area 1.1 via a conductor track. The identification means 4 (shown in FIG. 3) can be applied to the contact area 3, wherein, starting from the coupling area 1.1, capacitive coupling is performed from the coupling electrode 2 to the coupling-in electrode 9, wherein said coupling electrode 2 and coupling-in electrode 9 are connected to the data points 5 of the identification means via conductor track structures 6. The coupling area 1.1 is preferably touched by a user.

FIG. 4 shows a connection between identification means and basic object. The identification means 4 can be applied, for example, to the lower side of the first module (basic object) 1. However, it may also be advantageous to fasten a plurality of identification means 4 to different contact areas of the first module 1 (not illustrated).

FIG. 5 shows a modular object and a touchscreen, which have been brought into contact with one another.

The modular object 7 can effect an input on a touchscreen 8, wherein the object 7 is detected and identified by the device having the touchscreen.

FIGS. 6A-D show exemplary structures of the identification means. FIG. 6A shows a coupling-in electrode 9 of the identification means, via which a capacitive connection to the coupling electrode of the first module is produced. The coupling-in electrode 9 can be arranged in different positions on the identification means and is used in particular for capacitive coupling to the coupling electrode of the first module. In FIG. 6A, the coupling-in electrode 9 is positioned at the rim, with the result that the electrical connection between the coupling electrode and the coupling area on the basic object can be realized more easily in terms of manufacturing. In the case shown in FIG. 6B, the coupling-in electrode 9 is in the center. The coupling electrode on the first module (basic object) is then preferably likewise in the center. The identification means are in this case rotationally independent for the application to the first module, i.e. during a rotation of the identification means about the center point, the coupling electrode and the coupling-in electrode nevertheless always lie precisely one on top of the other. In FIG. 6C, the coupling-in electrode is in the form of a conductor track structure 6, which has a ring shape. The data points 5 lie on the ring structure 6. The coupling-in with the coupling electrode of the first module can take place via the ring 6 or one of the data points 5. During coupling-in via the ring 6, it is advantageous that said ring is rotationally independent again. In FIG. 6D, the data points 5 are not connected; they are connected to one another directly via the basic object, for example in the case of a can as the basic object, all of the data points need to lie on a circular ring in order that they can be coupled in. Each point acts as coupling-in electrode and data point in one (in examples A-C, in each case only one data point acts as coupling-in electrode).

FIGS. 7A-C show views of an exemplary chip (for example poker chip). The modular object can be configured with different forms. For example, the modular object can be in the form of a chip. The chip, in particular the first module 1 of the chip, has in particular a contact area 3 with a coupling electrode 2 on the lower side. The identification means 4 is fastened to the contact area 3 of the first module 1. The identification means 4 has electrically conductive layers, in particular subareas, which are configured as data points 5. One of the data points is at the same time the coupling-in electrode 9. The data points 5 are connected to one another via conductor track structures 6. The chip upper side preferably consists of electrically conductive material. The conductor track shown in FIG. 7B produces the connection between the electrically conductive surface (coupling area) and the coupling electrode 2.

FIGS. 8A-C show views of an exemplary can. Cans typically consist of metal and are electrically conductive. The ring on which the can is standing (shown somewhat more broadly in FIG. 8B) is used as the coupling electrode 2. The coupling-in electrodes 9 are directly on the coupling electrode 2 of the can, which in this case corresponds to the can ring, in FIG. 8C. The ring on the identification means 4 connects the coupling-in electrodes 9. The coupling-in electrodes 9 on their own are preferably so small that they do not initiate touch events on the touchscreen and are at the same time in total so large that sufficient coupling-in area is available. The ring connects the coupling-in areas which are connected to the point structure (data points 5) via conductor track structures 6.

FIGS. 9A-D show views of an exemplary die. FIG. 9A shows a die with a normal appearance, to which identification means are applied. FIG. 9B shows a die as a first module 1 (basic object) without identification means, but with coupling electrodes 2 and contact areas 3. FIGS. 9C and D show the front side (FIG. 9C) and rear side (FIG. 9D) of the identification means 4. Data points 5 and conductor track structures 6 are applied to the rear side of the identification means 4, with the result that capacitive coupling-in with the first module can take place and an input on a touchscreen can be achieved.

FIGS. 10A and B illustrate a use of a fastening means in a modular object. A sketch is depicted of an object from below with a battery compartment 10. In this case, a screw (but several screws would also be possible) lies in a plane with the cover. This screw later rests on the touchscreen and is used in particular as coupling electrode 2 for the identification means 4 and produces a connection to the coupling area (not illustrated) in the interior of the battery compartment 10. The three other screws illustrated are preferably only used for fastening purposes. They are set deeper and do not have any contact with the identification means 4 and do not initiate any input on the touchscreen. The identification means 4 is configured appropriately for the cover of the battery compartment 10. In the example, the rear side of the identification means 4 with a structure comprising data points 5 and conductor track structures 6 is illustrated. This structure is not visible from the outside.

FIG. 11 shows a further preferred embodiment of the modular object. The figure comprises two first modules (basic objects) and a second module. The upper first module 1 is a conductive or conductively coated basic object with a coupling area 1.1 and a coupling electrode (not visible, on the base of the module). The central module (the second basic object) comprises a conductive part (black) and an electrically nonconductive part (white). The area on which the upper first module 1 is applied is the coupling area 1.1. The coupling electrode (not visible) then couples over to the identification means 4.

FIG. 12 and FIG. 13 show further preferred embodiments. By way of example, the surprising advantage of a modular design is shown, whereby an identical identification means enables different effects for identification by means of another configuration of the first and second modules. In the case of FIG. 12, the coupling electrode 2, by touching of the coupling area 1.1 via the conductor track structures 6, produces a capacitive coupling with a first part of the identification means 4. However, in the case of FIG. 13, an identical coupling electrode 2 brings about a capacitive coupling with a second part of the identification means 4.

FIG. 14 shows the capacitive coupling between a first module comprising a coupling area 1.1, a conductor track structure 6 and a coupling electrode 2 to a second module comprising an identification means with data points 5.

It can be seen from the figures that the modular object can have different configurations and can be implemented differently. Different forms can be subsumed under the invention, wherein the principle of the modular object can also be integrated in existing forms (such as, for example, cans or chips) by simple means.

### LIST OF REFERENCE SYMBOLS

1 first module
1.1 coupling area
2 coupling electrode
3 contact area
4 identification means
5 data points
6 conductor track structures
7 modular object
8 touchscreen
9 coupling-in electrode
10 battery compartment

1. A modular playing figure for identification by touchscreens, comprising at least a first and a second module, wherein
a. the first module is a basic object having an at least partially electrically conductive surface, which is electrically conductively connected to a coupling electrode on a contact area, and
b. the second module is an identification means comprising at least one electrically conductive layer, wherein the electrically conductive layer comprises at least one coupling-in electrode,
wherein the basic object and the second module are connected to one another in a cohesive, force-fitting and/or form-fitting manner in such a way that the coupling electrode on the contact area of the basic object and the coupling-in electrode of the second module have been brought into contact with one another.

2. The modular playing figure as claimed in claim 1, wherein the electrically conductive elements of the modules are not provided in a developable surface.

3. The modular playing figure as claimed in claim 1 or 2, wherein the first and second modules are capacitively coupled or directly electrically connected to one another.

4. The modular playing figure as claimed in one or more of the preceding claims, wherein one or more identification means are applied directly or indirectly to the basic object.

5. The modular playing figure as claimed in one or more of the preceding claims, wherein the coupling electrode is in the form of an electrically conductive layer on the contact area of the basic object at least as a subarea.

6. The modular playing figure as claimed in one or more of the preceding claims, wherein one or more electrically conductive fastening means are applied to the contact area of the basic object and can act at least partially as coupling electrode.

7. The modular playing figure as claimed in one or more of the preceding claims, wherein the identification means is connected to the basic object by means of injection-molding methods, particularly preferably film insert molding, in-mold methods, welding methods and/or adhesive bonding.

8. The modular playing figure as claimed in one or more of the preceding claims, wherein the identification means is produced and/or applied to the basic object by means of an additive, semiadditive or subtractive method.

9. The modular playing figure as claimed in one or more of the preceding claims, wherein the identification means is produced by a printing method, preferably a mass printing method.

10. The modular playing figure as claimed in one or more of the preceding claims, wherein the identification means is produced by a transfer foil method, preferably a metal foil transfer method, and particularly preferably by a cold foil transfer method.

11. The modular playing figure as claimed in one or more of the preceding claims, wherein the electrically conductive areas of the identification means are in the form of subareas, in particular filled circles or circular rings, wherein subareas are electrically connected by means of line structures, and wherein at least one subarea is the coupling-in electrode.

12. The modular playing figure as claimed in one or more of the preceding claims, wherein the first and/or second module has at least one further coating.

13. The modular playing figure as claimed in one or more of the preceding claims, wherein the coupling electrode of the basic object and the coupling-in electrode of the identification means are connected to one another in such a way that there is the greatest possible overlap.

14. A system comprising a modular playing figure as claimed in claims 1 to 13 and a touchscreen or a device containing a touchscreen, wherein at least part of the playing figure has been brought into contact with the touchscreen.

15. The system as claimed in claim 14, wherein the playing figure is being touched permanently or non-permanently by a user.

16. The use of the playing figures as claimed in one of claims 1 to 15 for providing different touch structures by virtue of different modules being combined with one another.

17. The use of the playing figures as claimed in one of claims 1 to 15 as playing figure for interaction with a touchscreen, wherein at least part of the playing figures has been brought into contact with the touchscreen.

18. The use as claimed in one of the preceding claims, wherein measured values are collected by virtue of rotation and/or translation of a playing figure on the touchscreen and stored as reference values, and these reference values are matched with other measured values at a later point in time in order to identify the figure.

19. The use as claimed in one of the preceding claims, wherein interaction between at least one figure, a user and/or touchscreen or a touchscreen-containing device takes place.

20. The use as claimed in one or more of the preceding claims, wherein the presence, permanent or non-permanent touching contact, identity, orientation, rotation and/or movement of at least one figure is detected by the touchscreen or a device having a touchscreen.
